(19) United States
(12) Patent Application Publication
(10) Pub. No.: US 2017/0159352 A1
(43) Pub. Date: Jun. 8, 2017

(54) WALL-INTEGRATED WINDOW PROTECTION SYSTEM

(71) Applicant: Deschenes & Cooper Architectural Millwork, LLC, Pawcatuck, CT (US)

(72) Inventors: Brian Cooper, North Stonington, CT (US); Robert Cooper, North Stonington, CT (US); Chad Sweet, North Stonington, CT (US)

(21) Appl. No.: 15/367,236

(22) Filed: Dec. 2, 2016

Related U.S. Application Data
(60) Provisional application No. 62/263,427, filed on Dec. 4, 2015.

(51) Int. Cl. E06B 5/10; E06B 9/74; E06B 9/17; E06B 9/72; E06B 1/36

(52) U.S. Cl. CPC E06B 5/10; E06B 9/72; E06B 1/36; E06B 9/17; E06B 9/74

(57) ABSTRACT

Window protection systems having a housing defining an interior space installable above a window, and a spool having a storm shutter wound thereon and contained within the interior space of the housing, the storm shutter configured to deploy from a first position to a second position, wherein, in the first position, the storm shutter is wound about the spool and contained within the interior space, and, in the second position, the storm shutter is deployed from the housing to protectively cover the window.

### CROSS-REFERENCE TO RELATED APPLICATIONS

The present application claims priority from U.S. Provisional Patent Application No. 62/263,427, filed Dec. 4, 2015. The contents of the priority application are hereby incorporated by reference in their entirety.

### BACKGROUND

The subject matter disclosed herein generally relates to window protection systems and, more particularly, to wall-integrated window protection systems.

Historic windows are an important character-defining feature for historic structures (e.g., houses, school buildings, libraries, etc.), and therefore preserving and maintaining historic windows, sashes, and other features of an historic structure is desired. Historic window details may contribute to the overall character and quality of the windows and the historic structure as a while. For example, features of historic windows that may contribute to the character and quality include, but are not limited to, the original configuration of sash and/or sash lights, the original material (e.g., wood), the original structure of the window (e.g., single-glazed, double hung sash with individual lights set in true divided muntins), the original profile of the window and surrounding structure (e.g., putty bevels on the exterior muntins, stiles and rails, and molded interior profiles), and the original finish material (e.g., a painted surface). Both the interior and the exterior characteristics may be of import in maintaining and preserving historic windows.

In many cases, historic windows may be successfully preserved through repair and maintenance. However, in certain instances, the historic windows may need to be replaced, rather than repaired. For example, some common problems that may lead to consideration of replacing a window and/or window sash may include: the historic windows are missing, replacement of non-historic (later installed) windows to restore the historic appearance, replacement of damaged or deteriorated historic windows, lead paint hazards and considerations, thermal efficiency, and maintenance and operation (e.g., ease of use for opening/closing).

If historic windows have previously been replaced, and new historic windows are desired to be installed, replacements may be found that match the historic window as closely as possible. For example, replacement taken from other structures of a similar design and time period may be found and installed as a restored historic replacement window.

If an historic window becomes damaged or deteriorated, such that repair may no longer be feasible, a replacement “in-kind” may be used. A replacement “in-kind” means that the original configuration of sash lights, the original material, the original structure, the original profile, and the original finish may be replicated in a newly manufactured window. In some instances, original finish materials may be removed, such as in the case of lead paint. Various other repairs, replacements, and other operations may be conducted to maintain and preserve historic windows.

### SUMMARY

According to one embodiment, window protection systems are provided. The window protection systems include a housing defining an interior space installable above a window, a spool having a storm shutter wound thereon and contained within the interior space of the housing, the storm shutter configured to deploy from a first position to a second position, wherein, in the first position, the storm shutter is wound about the spool and contained within the interior space, and, in the second position, the storm shutter is deployed from the housing to protectively cover the window.

In addition to one or more of the features described herein, or as an alternative, further embodiments of the window protection systems may include that the housing is a window header and fits within a wall of a structure and hide the storm shutter within the interior space when in the first position.

In addition to one or more of the features described herein, or as an alternative, further embodiments of the window protection systems may include a motor configured to drive the storm shutter from the first position to the second position and from the second position to the first position.

In addition to one or more of the features described herein, or as an alternative, further embodiments of the window protection systems may include that the motor is housed within the spool.

In addition to one or more of the features described herein, or as an alternative, further embodiments of the window protection systems may include a controller configured to control the motor to deploy the storm shutter from the first position to the second position and retract the storm shutter from the second position to the first position.

In addition to one or more of the features described herein, or as an alternative, further embodiments of the window protection systems may include that the storm shutter and the spool form an integral unit.

In addition to one or more of the features described herein, or as an alternative, further embodiments of the window protection systems may include a window frame, wherein the housing forms a header of the window at a top of the window frame.

In addition to one or more of the features described herein, or as an alternative, further embodiments of the window protection systems may include at least one shutter track within the window frame and configured to enable the storm shutter to move within the shutter track when moving between the first and second positions.

In addition to one or more of the features described herein, or as an alternative, further embodiments of the window protection systems may include a sill at a bottom of the window frame, wherein the storm shutter is configured to extend from the header to the sill.

In addition to one or more of the features described herein, or as an alternative, further embodiments of the window protection systems may include that an end of the storm shutter sealingly engages with the sill when in the second position.

In addition to one or more of the features described herein, or as an alternative, further embodiments of the window protection systems may include that the storm shutter is manually operable between the first and second positions.

In addition to one or more of the features described herein, or as an alternative, further embodiments of the window protection systems may include a mechanism to stop the storm shutter from deploying from the first position to the second position if an object obstructs the movement of the storm shutter when moving from the first position to the second position.

In addition to one or more of the features described herein, or as an alternative, further embodiments of the window protection systems may include that a portion of the housing matches a characteristic of a structure into which the housing is installed.

In addition to one or more of the features described herein, or as an alternative, further embodiments of the window protection systems may include that the characteristic is at least one of a material, a finish, a design, or an architectural characteristic.

In addition to one or more of the features described herein, or as an alternative, further embodiments of the window protection systems may include that the housing includes a first face and a second face, wherein the first face matches an exterior of a structure to which the window protection system is installed and the second face matches an interior of the structure to which the window protection system is installed.

According to another embodiment, windows for structures are provided. The windows include a window frame having a header and a sill, at least one sash installed within the window frame, and a window protection system installed within the header. The window protection system includes a spool having a storm shutter wound thereon, the storm shutter configured to deploy from a first position to a second position, wherein, in the first position, the storm shutter is wound about the spool and contained within the header, and, in the second position, the storm shutter is deployed from the housing to protectively cover the at least one sash.

In addition to one or more of the features described herein, or as an alternative, further embodiments of the windows may include a motor configured to drive the storm shutter from the first position to the second position and from the second position to the first position.

In addition to one or more of the features described herein, or as an alternative, further embodiments of the windows may include that the motor is housed within the spool.

In addition to one or more of the features described herein, or as an alternative, further embodiments of the windows may include at least one shutter track within the window frame and configured to enable the storm shutter to move within the shutter track when moving between the first and second positions.

In addition to one or more of the features described herein, or as an alternative, further embodiments of the windows may include that an end of the storm shutter sealingly engages with the sill when in the second position.

Technical effects of embodiments of the present disclosure include a window protection system that is integrated into a wall of a structure such that a storm shutter is not visible from the exterior of the structure. Further technical effects include automatically or manually operated window protection systems that are configured to be hidden from view.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a perspective view of a window that may employ embodiments described herein;

FIG. 2A is an elevational front view of a window and window protection system in accordance with the present disclosure;

FIG. 2B is a side, cross-sectional view of the window and system of FIG. 2A;

FIG. 2C is a plan, cross-sectional view of the window and system of FIG. 2A;

FIG. 3 is a partial cross-sectional cut-away view of a window having a window protection system in accordance with an embodiment of the present disclosure installed therewith;

FIG. 4 is a schematic illustration of a window protection system in accordance with an embodiment of the present disclosure; and

FIG. 5 is a partial cross-sectional illustration of a window protection system in accordance with the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “X##” and a similar feature in FIG. Z may be labeled “Z##.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

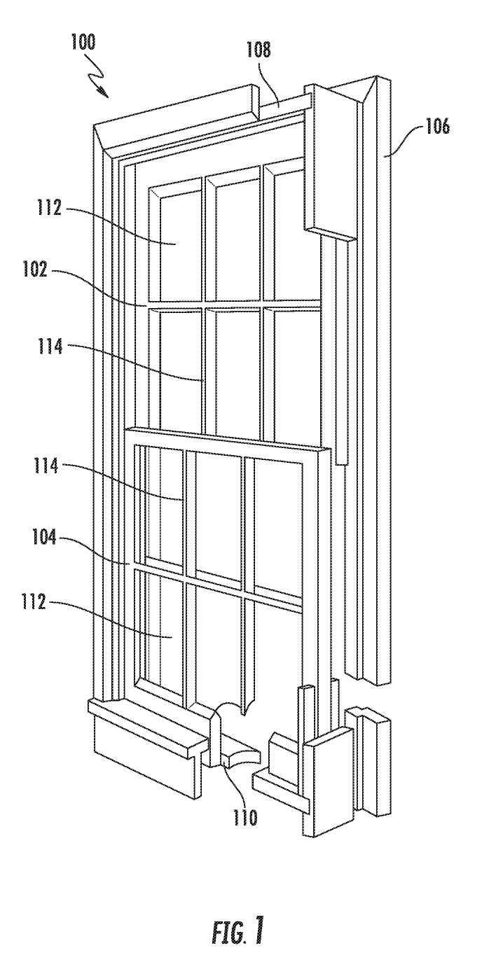

FIG. 1 is a partial schematic illustration of a window 100 that may employ embodiments described herein. The window 100 includes a first or upper sash 102 and a second or lower sash 104. Each sash 102, 104 may be configured to move (e.g., slide or translate) within a frame 106. The frame 106 may include guides (not shown) to enable movement of the sashes 102, 104 within the frame 106. The top of the frame 106, as shown, is configured having a jamb 108 that stops or prevents the sashes 102, 104 from moving above a specific height or level. Similarly, the bottom of the frame 106, as shown, is configured as having a sill 110. The sill 110 defines a lower limit of the movement of the sashes 102, 104 within the frame 106. The guides of the frame 106 can extend through or along at least a portion of the frame 106 that extends vertically between the sill 110 and the jamb 108. The frame 106, in some configurations, can be configured to be installed and fit within a wall of a structure (not shown), such as a house, building, etc.

Each sash 102, 104, as shown, includes one or more sash lights 112. Sash lights 112, as used herein, are one or more glass or other material panes that are installed within the window 100. In the window 100, shown in FIG. 1, muntins 114 are provided to support the sash lights 112 within each sash 102, 104. The muntins 114 may be configured as bars or rigid supporting strip or structures that are positioned between adjacent panes of glass or other material (e.g., adjacent sash lights 112). In some embodiments, the muntins 114 can be merely aesthetic, with a single large sash light 112 within the first and second sashes 102, 104, i.e., a single pane of glass or other material is fit within the respective sashes 102, 104.

It may be beneficial to protect the sash lights 112 and the other structures and/or features of the window 100. For example, in historic structures, maintaining the character of the windows may be desired, and thus protecting the windows (e.g., sash lights, muntins, etc.) from damage may be beneficial. One method for protecting windows can be by providing a shutter or other device that covers the window in the event of weather phenomena, such as storms, hurricanes, tornados, hails, etc.

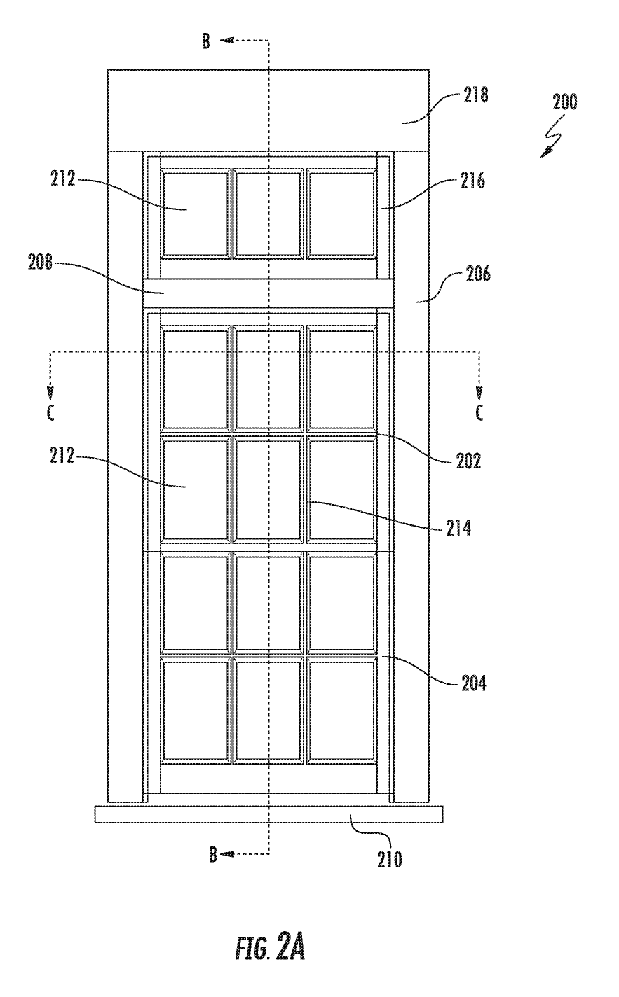

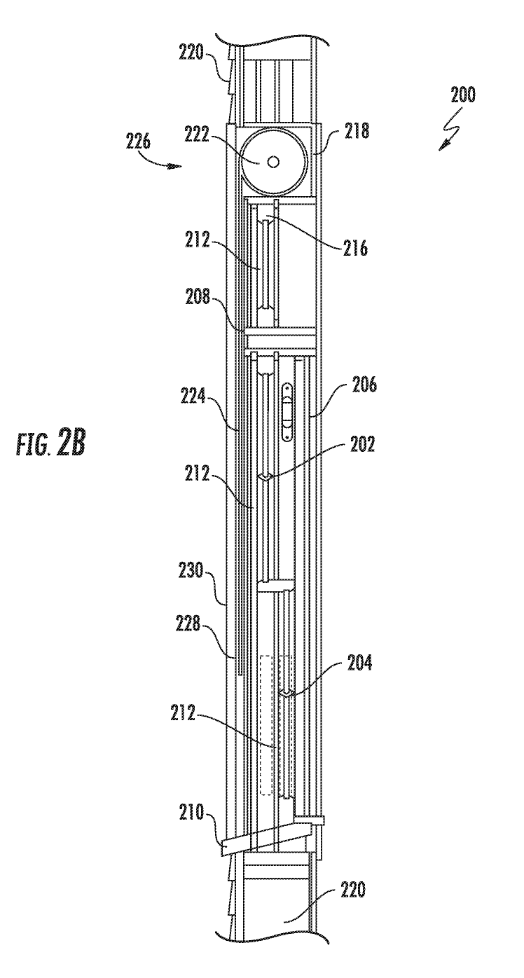

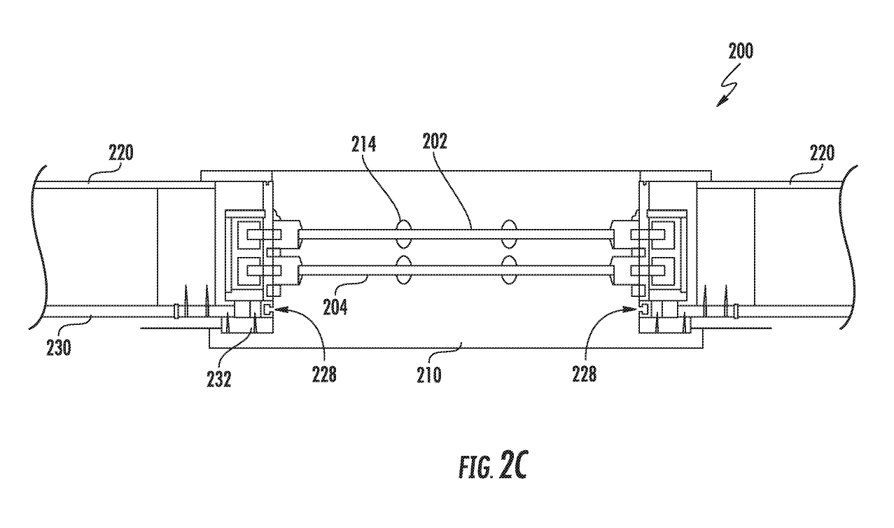

Turning to FIGS. 2A-2C, schematic illustrations of a window configuration in accordance with an embodiment of the present disclosure are shown. FIG. 2A is an elevational schematic illustration of a window 200 having a window protection system installed therewith and as described below. FIG. 2B is a side cross-sectional elevational illustration of the window 200 as viewed along the line B-B shown in FIG. 2A. FIG. 2C is a top down, cross-sectional plan illustration of the window 200 as viewed along the line C-C shown in FIG. 2A.

As shown in FIG. 2A, the window 200 includes a frame 206 that houses a first sash 202, a second sash 204, and a third sash 216. A jamb 208 is positioned between the first sash 202 (e.g., an upper sash) and the third sash 216. Each of the sashes 202, 204, 216, as shown, includes one or more sash lights 212. The first sash 202 and the second sash 204 are configured to move vertically within the frame 206 between the jamb 208 as an upper limit and a sill 210 as a lower limit, with the first and second sashes 202, 204 movable within and along one or more guides in the frame 206. The third sash 216 is configured as a stationary sash that is bound by the vertical portions of the frame 206, the jamb 208, and a housing or header 218.

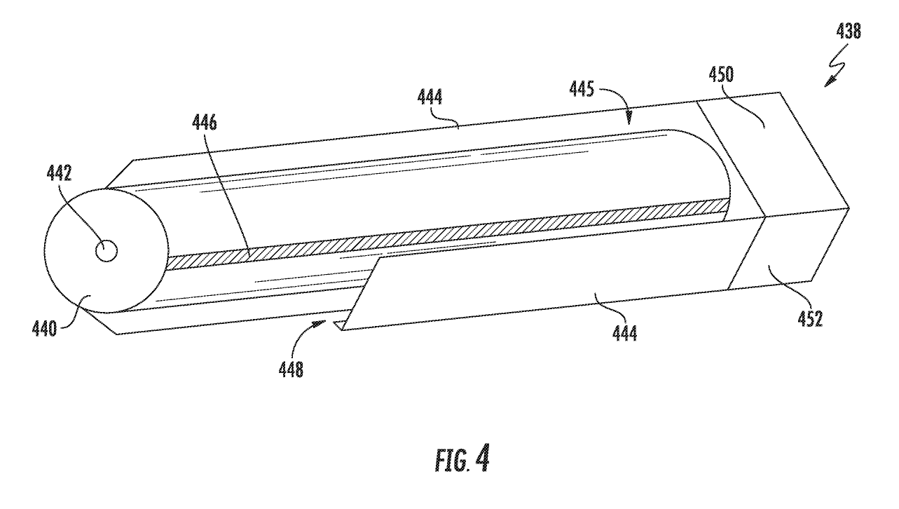

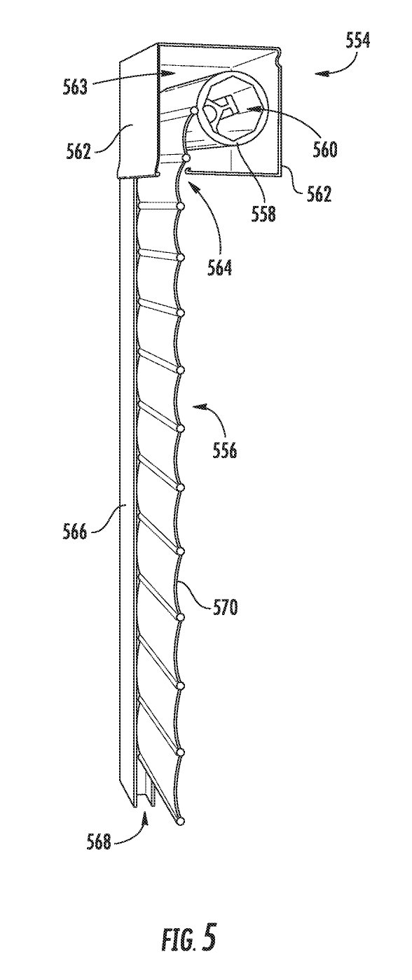

In accordance with a non-limiting embodiment of the present disclosure, the header 218 contains a window protection system 226 therein, as shown in FIG. 2B. The window protection system 226 can be a manually or automatically operated storm shutter system that operates from a first or stowed position (e.g., as shown in FIG. 2A and FIG. 4) to a second or deployed position (e.g., as shown in FIG. 2B and FIG. 5). In the first position, portions of the window protection system 226 may not be visible from the exterior or the interior of the structure and, in some embodiments, may be completely hidden from view. For example, on the interior of the structure, molding or other coverings may be provided and/or installed over portions of the window protection system 226. In other embodiments, the window protection system 226 may be completely hidden or contained within a framing of the structure. When deployed to the second position, a portion of the window protection system 226 provides protection to the window 200.

Turning now to FIG. 2B, a side, cross-sectional elevation view of the window 200 is shown as viewed along the line B-B shown in FIG. 2A. The frame 206 is installed or integrated into and, as shown, relatively flush with a wall 220 of a structure, such as a house. As shown, the sill 210 provides an interface between the window 200 and the wall 220 at a lower end, and similarly the header 218 provides an interface between the window 200 and the wall 220 at an upper end.

As shown, the window protection system 226 is configured and housed within the header 218. The window protection system 226 includes a spool 222 that is rotatable to extend a storm shutter 224 over an exterior of the window 200 to protect the window 200 (e.g., muntins 214, sash lights 212, etc.). In some embodiments, the spool 222 is a round rod or structure that can be rotatably driven to wind and unwind the storm shutter 224 that is wound thereabout. However, in other embodiments, the spool 222 and the storm shutter 224 can be integrally formed such that the spool 222 is a portion of the storm shutter 224 that is driven to rotate and deploy or retract the storm shutter 224 as described herein. In one non-limiting embodiment, the storm shutter 224 can be configured to withstand hurricane force winds up to 140 miles per hour (62.6 m/s). Various other embodiments can be configured such that the deployable storm shutter is selected to withstand and/or protect against other wind speeds and/or natural phenomena such as ice, hail, debris, etc.

In the embodiment shown in FIGS. 2A-2C, the window protection system 226 is configured with a motorized storm shutter 224 that is integrated into the structure of the window 200. Accordingly, the window protection system 226 includes the spool 222, the storm shutter 224, and other components including, for example, a motor, a controller, etc. that enable motorized and/or automatic operation of the window protection system 226. The storm shutter 224 is wound about or coiled about the spool 222 such that the storm shutter 224 is housed within the header 218.

During a deployment operation, the storm shutter 224 is unspooled from the spool 222 and extends downward from the header 218. The deployment of the storm shutter 224 can be guided along shutter tracks 228 (as shown in FIG. 2C). The storm shutter 224 is deployable from the header 218 to along the shutter tracks 228 to the sill 210 at a lower end. The storm shutter 224 is configured to sealingly engage with the sill 210. As such, the storm shutter 224 is retained within and/or to the frame 206 within the shutter tracks 228 to provide a seal with the sill 210 such that portions of the window 200 may be protected from an exterior environment. Deployment moves the storm shutter 224 from the first or stowed position to the second or deployed position. The reverse operation can be performed to restow the storm shutter 224 within the header 218.

Although described herein as an automatic and/or motorized operation, window protection systems in accordance with the present disclosure can be configured to be manually operated, such as by crank or other handle. The manual operation can be the sole mechanism for operation, or in some embodiments, the manual operation can provide a backup mechanism for operation (e.g., if the motor fails, etc.).

In one non-limiting example, the window 200 is an historic window and is configured with true divided sashes 202, 204 (e.g., separate sash lights) built to replicate historic windows. The muntins 214 may be molded to look like glazed windows but in fact the entire exterior may be formed of wood. This can allow designs that are desired without restrictions imposed by a window built of hurricane glass and applied dividers (e.g., the glass and structure may be heavy, etc.).

In some embodiments, the window protection system 226 is installed such that the shutter track 228 is located behind an exterior casing 232 of the frame 206, e.g., an exterior portion of the frame 206, as shown in FIG. 2C. Because the shutter tracks 228 are configured within the frame 206 or at least behind the exterior casing 232 of the window 200, the storm shutter 224 may be able to cover and protect the exterior surfaces and features of the window 200 when the storm shutter 224 is deployed into the second or deployed position.

In some embodiments, the operation (e.g., opening and closing) of the window protection system 226 may be done remotely and tied into a home automation program or system. For example, with a smart home or other internet connected features, a user can remotely control the window protection system 226 through a web-based application or mobile device application. In some embodiments, the window protection system can be installed on various opening or portals in a building or other structures, such as windows, doors, etc. In such configurations, the window protection system 226 can be configured to provide security against break-ins and/or vandalism.

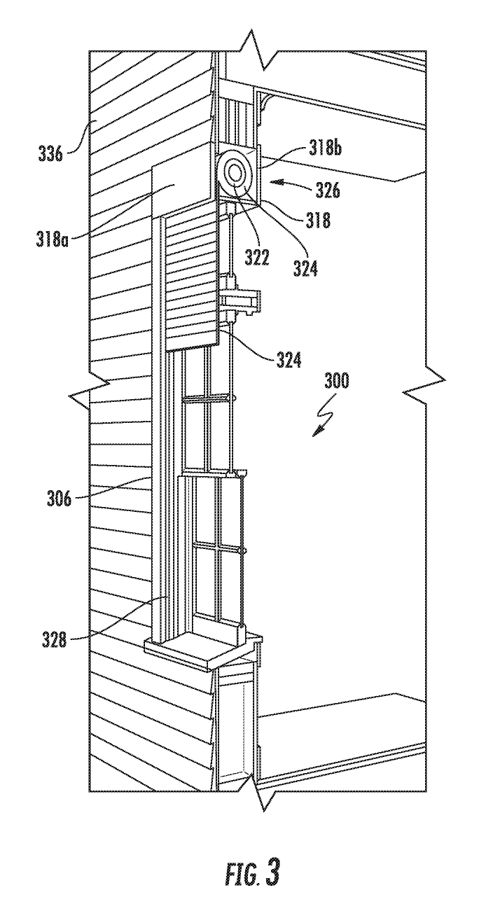

Turning now to FIG. 3, a partial cross-sectional cut-away view of a window 300 having a window protection system 326 installed within a structure 336 is shown. As shown, the window protection system 326 is shown in a partially extended or deployed position, with a storm shutter 324 partially covering the window 300. Further, as shown, the storm shutter 324 is operated within shutter tracks 328 which are contained within a frame 306 of the window 300.

As shown, the window protection system 326 includes a header 318 that houses a spool 322 with the storm shutter 324 wound thereabout. The header 318 also forms a portion of the aesthetic of the window 300. For example, the header 318 includes a first or exterior face 318a which is exposed to an exterior of the structure 336. A second or interior face 318b of the header 318 is exposed to an interior of the structure 336. In some embodiments, the first face 318a of the header 318 may be configured to match features of the exterior of the structure 336 and the second face 318b may be configured to match features of the interior of the structure 336. Thus, in some embodiments, the window protection system 326 may be hidden from view both from the interior and the exterior of the structure 336. In some embodiments, one or both of the first face 318a and the second face 318b are selected to match a characteristic of a structure into which the housing 318 is installed. For example, in some embodiments, the one or both faces 318a, 318b of the housing 318 can be configured to match a characteristic such as a material, a finish, a design, or an architectural characteristic of the building or structure into which the housing 318 is installed.

In some embodiments, a mechanism to stop the storm shutter 324 from deploying if an object obstructs the movement of the storm shutter 324 when moving from the first position to the second position may be provided. For example, when deploying from the stowed position to the deployed position, if a portion, such as a lower end, of storm shutter 324 contacts a person or item that obstructs the storm shutter 324 from fully deploying, the window protection system 326 may stop the deployment operation. In some embodiments, when an object is contacted that obstructs the full deployment of the storm shutter 324, the window protection system 326 can be configured to automatically drive the storm shutter 324 back to the first/stowed position. Such safety mechanisms can include optical sensors, pressure sensors, electrical and/or mechanical switches, etc. as will be appreciated by those of skill in the art. In some embodiments, for example, the safety mechanism can be an auto-reverse that occurs when resistance is detected during deployment.

The shutter and window protection systems of the present disclosure can be made from various materials. For example, the storm shutter may be aluminum, steel, or other metal that is selected to provide protection to the window. In some embodiments, the storm shutter may be made of composite materials, cloth, fabric, or from other materials, which can be selected, for example, to provide protection to the window. The header that contains the spooled storm shutter may be made of various materials such that the header can aesthetically match the structure into which the window protection system is installed. In some embodiments, the first, exterior face of the header may be a different material than the second, interior face of the header.

Turning now to FIG. 4, a schematic illustration of a window protection system 438 in accordance with an embodiment of the present disclosure is shown. The window protection system 438 may be similar to the window protection systems described above. As shown in FIG. 4, the window protection system 438 is in a first or stowed position.

The window protection system 438 includes a storm shutter 440 that is wound or wrapped about a spool 442. The spooled storm shutter 440 is contained within an interior space 445 of a housing 444 (e.g., a header as described above). The shutter 440 includes a shutter end 446 that is configured to provide sealing engagement with a sill of a window, such as described above. The shutter end 446 can further include one or more features to enable engagement with and operation with shutter tracks to enable easy and accurate sealing deployment to protect a window.

As shown, the housing 444 is shown in partial cut-away for clarity of illustration. The housing 444 can have one or more faces as described above that can be configured to aesthetically match a portion of a structure (e.g., interior, exterior, etc.). The housing 444 includes a deployment gap 448 through which the storm shutter 440 can be deployed. The deployment gap 448 can be aligned with shutter tracks (e.g., as described above) within a frame of a window, such that the storm shutter 440 extends through the deployment gap 448 and into and along the shutter tracks.

As shown in FIG. 4, the window protection system 438 includes a motor 450 that is contained within a motor housing 452. In some embodiments, the motor housing 452 is integrally part of the housing 444 and is indistinguishable therefrom. As shown, the motor 450 is disposed at an end of the window protection system 438. The motor 450 is operably connected to the spool 442 such that operation of the motor 450 will drive the spool 442 to rotate and deploy or retract the storm shutter 440 wound on the spool 442.

In some embodiments, the motor 450 can be controlled through a switch, such as a light switch in a house that is proximate to the window protection system 438, or otherwise located. Additionally, or in the alternative, the motor 450 can be driven through commands received from a remote locations, either wired or wirelessly. For example, the window protection system 438 can be integrated into a home automation system such that a web-based application, remote controller, mobile application, computer, etc. can be used to control the window protection system to deploy or retract the storm shutter.

Further, in some embodiments, the motor can be contained within the spool, such that the motor is not at an end of the window protection system/housing. For example, turning to FIG. 5, a partial cross-sectional illustration of a window protection system 554 in accordance with the present disclosure is shown. The window protection system 554 includes a storm shutter 556 that is wound about a spool 558. The spool 558, as shown, includes a motor cavity 560 that is configured to receive and house a motor (not shown). The motor is configured to rotatably drive the spool 558 to deploy and retract the storm shutter 556.

As shown in FIG. 5, the window protection system 554 includes a housing 562 defining an interior space 563 that contains the storm shutter 556, the spool 558, and the motor. The housing 562 has a deployment gap 564 through which the storm shutter 556 can be deployed. Also shown in FIG. 5 is a portion of a frame 566 that includes a shutter track 568 along which the storm shutter 556 can be guided.

Further, as shown in FIG. 5, the storm shutter 556 is formed of a number of shutter segments 570. The shutter segments 570 can be sized and shaped to wrap about the spool 558 for storage and deployment and also selected to provide sufficient protection to a window when fully deployed. In other embodiments, the storm shutter may be a continuous or unbroken material that can be spooled and deployed.

Advantageously, embodiments described herein provide a window protection system that may be integrated into a structure such that the window protection system may not be visible from the exterior of the structure. Further, embodiments provided herein enable the protection of historic windows with a shutter that does not detract from the historic character of the window and/or structure into which the system is installed.

The window protection systems of the present disclosure can be preinstalled and configured with manufactured windows, such was built-in to a frame and header of such windows. However, in some embodiments, the window protection systems of the present disclosure can be retrofit into existing structures. For example, the window protection system shown in FIG. 4 can be a stand-alone unit that can be installed into an existing structure, with the framing and/or structure modified to receive the window protection system.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A window protection system comprising:
a housing defining an interior space installable above a window; and
a spool having a storm shutter wound thereon and contained within the interior space of the housing, the storm shutter configured to deploy from a first position to a second position,
wherein, in the first position, the storm shutter is wound about the spool and contained within the interior space, and, in the second position, the storm shutter is deployed from the housing to protectively cover the window.

2. The window protection system of claim 1, wherein the housing is a window header and fits within a wall of a structure and hide the storm shutter within the interior space when in the first position.

3. The window protection system of claim 1, further comprising a motor configured to drive the storm shutter from the first position to the second position and from the second position to the first position.

4. The window protection system of claim 3, wherein the motor is housed within the spool.

5. The window protection system of claim 3, further comprising a controller configured to control the motor to deploy the storm shutter from the first position to the second position and retract the storm shutter from the second position to the first position.

6. The window protection system of claim 1, wherein the storm shutter and the spool form an integral unit.

7. The window protection system of claim 1, further comprising a window frame, wherein the housing forms a header of the window at a top of the window frame.

8. The window protection system of claim 7, further comprising at least one shutter track within the window frame and configured to enable the storm shutter to move within the shutter track when moving between the first and second positions.

9. The window protection system of claim 7, further comprising a sill at a bottom of the window frame, wherein the storm shutter is configured to extend from the header to the sill.

10. The window protection system of claim 9, wherein an end of the storm shutter sealingly engages with the sill when in the second position.

11. The window protection system of claim 1, wherein the storm shutter is manually operable between the first and second positions.

12. The window protection system of claim 1, further comprising a mechanism to stop the storm shutter from deploying from the first position to the second position if an object obstructs the movement of the storm shutter when moving from the first position to the second position.

13. The window protection system of claim 1, wherein a portion of the housing matches a characteristic of a structure into which the housing is installed.

14. The window protection system of claim 13, wherein the characteristic is at least one of a material, a finish, a design, or an architectural characteristic.

15. The window protection system of claim 1, the housing including a first face and a second face, wherein the first face matches an exterior of a structure to which the window protection system is installed and the second face matches an interior of the structure to which the window protection system is installed.

16. A window for a structure, the window comprising:
a window frame having a header and a sill;
at least one sash installed within the window frame; and
a window protection system installed within the header, the window protection system including:
a spool having a storm shutter wound thereon, the storm shutter configured to deploy from a first position to a second position,
wherein, in the first position, the storm shutter is wound about the spool and contained within the header, and, in the second position, the storm shutter is deployed from the housing to protectively cover the at least one sash.

17. The window of claim 16, further comprising a motor configured to drive the storm shutter from the first position to the second position and from the second position to the first position.

18. The window claim 17, wherein the motor is housed within the spool.

19. The window of claim 16, further comprising at least one shutter track within the window frame and configured to enable the storm shutter to move within the shutter track when moving between the first and second positions.

20. The window of claim 16, wherein an end of the storm shutter sealingly engages with the sill when in the second position.
